(19) United States
(12) Patent Application Publication
(10) Pub. No.: US 2026/0192235 A1
(43) Pub. Date: Jul. 9, 2026

(54) CANISTER

(71) Applicant: AISAN KOGYO KABUSHIKI KAISHA, Obu-shi (JP)

(72) Inventor: Akiko BAN, Tokai-shi (JP)

(73) Assignee: AISAN KOGYO KABUSHIKI KAISHA, Obu-shi (JP)

(21) Appl. No.: 19/366,655

(22) Filed: Oct. 23, 2025

(30) Foreign Application Priority Data
Nov. 5, 2024 (JP) 2024-193714

(51) Int. Cl. B01D 53/04; F02M 25/08

(52) U.S. Cl. CPC B01D 53/0415; F02M 25/0854; B01D 2253/102; B01D 2257/702; B01D 2259/4516; B01D 2259/4566

(57) ABSTRACT

A canister has a casing filled with an adsorbent. A mounting plate extends from the casing's outer wall surface, with a fastening portion for vehicle attachment. The mounting plate is at least partially inclined downward from the fastening portion to a drain hole located between the casing and the fastening portion.

### CROSS-REFERENCE TO RELATED APPLICATIONS

This application claims priority to Japanese patent application serial number 2024-193714 filed Nov. 5, 2024, which is incorporated herein by reference in its entirety for all purposes.

### STATEMENT REGARDING FEDERALLY SPONSORED RESEARCH OR DEVELOPMENT

Not applicable.

### BACKGROUND

The present disclosure relates generally to canisters.

Vehicles such as automobiles equipped with an engine typically include a canister for capturing evaporated fuel generated from a fuel tank. One canister is mounted to a frame of the vehicle frame via a mounting portion such as a bracket.

The existing canister does not have a structure that actively drains water when the mounting portion on the vehicle body becomes submerged. Therefore, there is a need for an improved canister that can promote drainage from the mounting portion when submerged.

### SUMMARY OF THE INVENTION

In one aspect of this disclosure, a canister includes a casing filled with an adsorbent, and a mounting plate extending from an outer wall surface of the casing. The mounting plate includes a fastening portion configured to secure the mounting plate to a vehicle. The mounting plate is at least partially inclined downward from the fastening portion to a drain hole, which is located between the casing and the fastening portion.

### BRIEF DESCRIPTION OF THE DRAWINGS

FIG. 1 is a front view of an embodiment of the canister having a mounting plate.

FIG. 2 is a plan view of the mounting plate of the canister of FIG. 1.

FIG. 3 is a cross-sectional view of the mounting plate of FIG. 2, along the III-III line.

### DETAILED DESCRIPTION

Some embodiments of the present disclosure are described below in reference to the drawings.

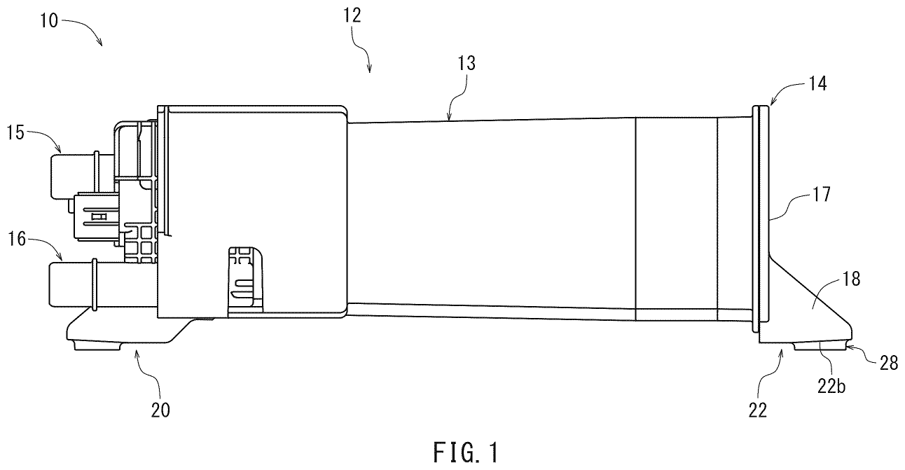

FIG. 1 shows an embodiment of a canister 10 that is configured to be mounted on a vehicle such as an automobile equipped with an engine. The canister 10 is filled with an adsorbent such as activated carbon for capturing evaporative fuel (fuel vapor) generated in a fuel tank (not shown). The fuel stored in the fuel tank is drawn out by a fuel pump and supplied to the engine through a supply passage. Meanwhile, the fuel tank is communicated with the atmosphere via a vent passage to relieve pressure fluctuations, e.g. occurring during parking. The vent passage includes the canister 10 as one of its components for preventing the evaporative fuel from flowing from the fuel tank into the atmosphere when the fuel tank pressure increases.

The canister 10 has a casing 12 that houses the adsorbent. The casing 12 may consist of a rectangular casing body 13, with one open end and a lid member 14. The casing 12 of the canister 10 is provided with a tank port 15 and an atmospheric port 16. The tank port 15 connects to a vapor passage communicating with the fuel tank. The atmospheric port 16 is connected to an atmospheric passage communicating with the atmosphere. The above-mentioned vent passage is composed of the canister 10, the vapor passage and the atmospheric passage. The casing 12 is additionally provided with a purge port (not shown) that is connected to the engine's intake manifold via a purge passage. The casing 12 defines a fluid passage therein such that multiple adsorption layers, each comprising adsorbents such as activated carbon, are arranged within the fluid passage.

The canister 10 can be mounted to frame members, such as side or cross members that constitute the lower structure of the vehicle body. The canister 10 has at least one mounting plate (two mounting plates 20, 22 are shown in FIG. 1) that extends laterally from the outer wall surface of the casing 12. The canister 10 is attached to the vehicle using the mounting plates 20 and 22. In one embodiment, the mounting plates 20 and 22 extend laterally from the side wall surface 17 of the casing 12, specifically, the outer wall surface of the lid member 14. In another embodiment, the mounting plates 20 and 22 can be provided on other members that do not directly constitute the side wall of the casing 12. In one embodiment, the canister 10 can be mounted horizontally, as shown in FIG. 1, where the fluid flow inside the casing 12 is generally horizontal. In another embodiment, the canister 10 can be mounted in a different orientation, such as a vertical orientation or an inclined orientation. The following description focuses on the mounting plate 22 that extends from the side wall surface 17 of the lid member 14 of the casing 12, but the mounting plate 20 that extends from the casing body 13 can be similarly configured.

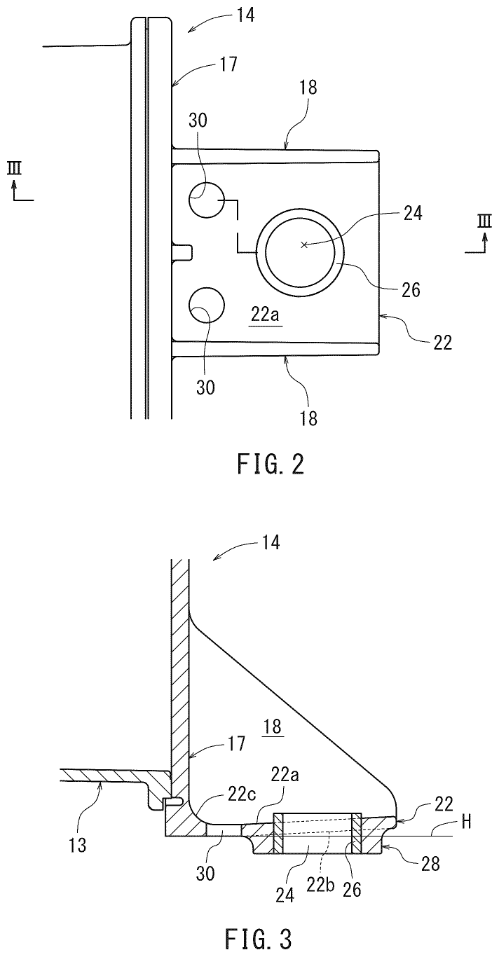

As shown in FIGS. 2 and 3, the lid member 14 includes a pair of reinforcing plates 18 that extends vertically between the mounting plate 22 and the side wall surface 17. The mounting plate 22 has a fastening portion, with an insertion hole 24 for passing a bolt. A metal collar 26, such as brass, is fitted into the insertion hole 24, either by insert molding or press fitting. When the canister 10 is attached to the vehicle, the collar 26 is tightened between a nut and a head of the bolt passing through the insertion hole 24. The mounting plate 22 may also have a support portion 28 that extends either downward or upward around the insertion hole 24. The canister 10 can be mounted directly to the vehicle's frame member or secured with a bracket.

The mounting plate 22 has at least one drain hole 30 (two shown in FIG. 2) extending through it. The drain holes 30 are positioned between the side wall surface 17 of the casing 12 and the insertion hole 24. The drain holes 30 can be any shape, such as circular or square. In one embodiment, the drain holes 30 are circular with a diameter of 5 mm or more. If not circular, the drain holes 30 can be shaped to have an equivalent or larger area than the 5 mm diameter circle.

As shown in FIG. 3, the mounting plate 22 is at least partially inclined from the horizontal plane H, with both its upper surface 22a and lower surface 22b sloping downward from the insertion hole 24 to the drain hole 30. This ensures that even if the mounting plate 22 becomes submerged, water on the upper surface 22a is guided into the drain holes 30, while water on the lower surface 22b flows away from the insertion hole 24. Vibrations during vehicle operation further assist this process. As a result, even if a bolt made of a corrosion-susceptible metal is used for fastening the mounting plate 22, a risk of corrosion-prone bolt rusting due to water pooling around the insertion hole 24 is reduced. The mounting plate 22 can be inclined in different ways. For example, the mounting plate 22 can have a uniform inclination from the insertion hole 24 toward the side wall surface 17 of the casing 12, or it can have separate inclined surfaces that lead from the insertion hole 24 to each of the two drain holes 30.

The upper surface 22a of the mounting plate 22 has a concave curved surface 22c extending downward from the side wall surface 17 of the casing 12 to the drain holes 30. This ensures that any water flowing down the side wall surface 17 of the casing 12 is guided by the concave curved surface 22c directly into the drain holes 30 without stagnating at a corner formed between the side wall surface 17 of the casing 12 and the upper surface 22a of the mounting plate 22.

The present disclosure is not limited to the above-described embodiments. A person skilled in the art can make various substitutions, improvements, and modifications without departing from the scope of the present disclosure.

The present disclosure includes various aspects as follows. In a first aspect, a canister includes a casing filled with an adsorbent, and a mounting plate extending from an outer wall surface of the casing. The mounting plate includes a fastening portion configured to be secured to a vehicle, and a drain hole positioned between the casing and the fastening portion. The mounting plate is at least partially inclined downward from the fastening portion toward the drain hole.

In accordance with the first aspect, even if the mounting plate becomes submerged, water on its upper surface is guided toward the drain hole, and water adhering to its lower surface also flows away from the fastening portion. Vibration during vehicle operation promotes this flow. Consequently, even if the fastening portion includes a bolt made of a corrosion-susceptible metal, corrosion of the bolt due to water stagnation at the fastening portion can be suppressed.

In a second aspect of this disclosure, the mounting plate may include an upper curved surface that extends downward from the outer wall surface of the casing toward the drain hole.

In accordance with the second aspect, water flowing down the outer wall surface of the casing is also guided to the drain hole without stagnating at a corner formed between the outer wall surface and the upper surface of the mounting plate.

What is claimed is:

1. A canister comprising:
a casing filled with an adsorbent; and
a mounting plate extending from an outer wall surface of the casing,
wherein the mounting plate includes a fastening portion configured to secure the mounting plate to a vehicle, and a drain hole located between the casing and the fastening portion, and
wherein the mounting plate is at least partially inclined downward from the fastening portion to the drain hole.

2. The canister of claim 1, wherein the mounting plate includes an upper curved surface that extends downward from the outer wall surface of the casing to the drain hole.
